(19) United States
(12) Patent Application Publication
(10) Pub. No.: US 2004/0223351 A1
(43) Pub. Date: Nov. 11, 2004

(54) Power conversion apparatus and solar power generation system

(75) Inventors: Seiji Kurokami, Kyoto (JP); Nobuyoshi Takehara, Kyoto (JP); Fumitaka Toyomura, Nara (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/831,321

(22) Filed: Apr. 26, 2004

(30) Foreign Application Priority Data
May 9, 2003 (JP) 2003-132160

(51) Int. Cl. H02M 1/00

(52) U.S. Cl. 363/65

(57) ABSTRACT

In a power conversion apparatus having a plurality of transformers, each of the plurality of transformers includes an input terminal having a first polarity, an input terminal having a second polarity, a wiring unit to connect one end of a primary winding of the transformer to the input terminal having the first polarity and the other end of the primary winding of the transformer to the input terminal having the second polarity, and a switching element which is arranged in series between the wiring unit and the other end to control voltage application to the primary winding of the transformer. Part of the wiring unit is connected to one end or the other end to surround the transformer connected to the wiring unit. A solar power generation system includes a solar cell and the above power conversion apparatus.

### FIELD OF THE INVENTION

The present invention relates to a power conversion apparatus and solar power generation system.

### BACKGROUND OF THE INVENTION

There is a solar power generation system which causes a DC/DC converter to step up the output from a solar cell and supplies the power to a load such as an utility interactive inverter. An example of a circuit used for the DC/DC converter is a push-pull circuit shown in FIG. 9.

In this circuit, the output from a solar cell 1 is received by an input smoothing capacitor 2. In addition, switching elements 3a and 3b are alternately turned on/off on the basis of driving signals from a control circuit 5 to apply a high-frequency AC voltage to the primary windings (with center taps) of a transformer 4. The secondary winding of the transformer 4 outputs an AC voltage that is stepped up in accordance with the turn ratio of the primary and secondary windings. The AC voltage is converted into a DC voltage by a rectifying circuit 50 including diodes 50a, 50b, 50c, and 50d. The output is smoothed by an output filter 62 formed from an output smoothing choke 60 and output smoothing capacitor 61 so that the step-up voltage is fed to a load 7. When the system is driven specifically at a fixed duty of about 50%, the output filter 62 need not always be arranged near the rectifying circuit 50. Hence, the output filter 62 can be placed outside the DC/DC converter main body.

When a DC/DC converter having such a circuit arrangement should be arranged on one side of a solar cell and electrically connected and mechanically fixed to the solar cell, the DC/DC converter is preferably as small and thin as possible from the viewpoint of installation, management, and transportation while kept connected to the solar cell. In addition, to effectively use the power generated by the solar cell, the power conversion efficiency of the DC/DC converter is preferably as high as possible.

When a low-profile transformer is used as the transformer 4 in the DC/DC converter, the resistance loss, core loss, and leakage flux increase, resulting in a decrease in the power conversion efficiency of the DC/DC converter. When an almost cubic transformer is used, the advantages of a compact low-profile structure are sacrificed, although the power conversion efficiency of the DC/DC converter becomes high. That is, the conventional DC/DC converter can hardly simultaneously meet the requirements for a compact low-profile structure and a high power conversion efficiency.

There is also a push-pull circuit having a circuit arrangement as shown in FIG. 10. This circuit has two push-pull units formed from a set of the switching elements 3a and 3b and a transformer 4a, and another set of switching elements 3a and 3b and a transformer 4b, unlike the circuit shown in FIG. 9. The input sides of the two push-pull units are connected in parallel, and the output sides are connected in series. Such a push-pull circuit having a plurality of transformers can be made smaller and thinner than a circuit using one cubic transformer, or can be made to ensure a higher power conversion efficiency than a circuit using one low-profile transformer.

In this circuit, components are conventionally laid out as shown in FIG. 11. The same reference numerals as in FIG. 10 denote the same components in FIG. 11. In a DC/DC converter 100, the two push-pull units are arranged side by side. A negative-side main circuit wiring unit 20b common to the two push-pull units is arranged on the lower side of FIG. 11. A positive-side main circuit wiring unit 20a common to the two push-pull units is arranged on the left and upper sides of FIG. 11. That is, a main circuit wiring unit 20 surrounds the two push-pull units.

As shown in FIG. 12, a connection unit 10 of the DC/DC converter 100 shown in FIG. 11 is connected to solar cells 1200 by connection members 1208. A portion indicated by a dotted line in FIG. 11 is the connection unit 10 having a positive terminal 11a and negative terminal 11b, which is connected to solar cells to receive a current from them.

In installing a solar power generation system having the solar cells 1200 and DC/DC converter 100, to increase the power generation amount per installation area (i.e., the area power generation efficiency), it is preferable that the space except the solar cells 1200 is small, and the projecting width of the DC/DC converter 100 from the solar cells 1200 is small.

In the DC/DC converter 100 shown in FIG. 11, since the positive-side main circuit wiring unit 20a arranged on the upper side of FIG. 11 is led over a long distance, the wiring resistance readily increases. Since a low-voltage large-current power from the solar cells 1200 flows to the positive-side main circuit wiring unit 20a, it must be wide to some extent to decrease the loss. Accordingly, the projecting width of the DC/DC converter 100 from the solar cells 1200 becomes large.

When the positive-side main circuit wiring unit 20a is made narrow to decrease the projecting width of the DC/DC converter 100, the wiring resistance in the positive-side main circuit wiring unit 20a becomes high, and the power conversion efficiency of the DC/DC converter 100 decreases. That is, it is difficult to simultaneously satisfy a high power conversion efficiency and a compact low-profile structure of a DC/DC converter, or a high power conversion efficiency of a DC/DC converter and a high area power generation efficiency of a solar power generation system.

In addition, since the positive-side main circuit wiring unit 20a is long, the wiring resistance to the primary winding center taps changes between the two transformers. For this reason, the operation conditions of the two push-pull units do not balance, and the power conversion efficiency and operation stability decrease.

Furthermore, since the DC/DC converter 100 shown in FIG. 11 is long in the horizontal direction, the distances from the control circuit 5 to the switching elements 3a to 3d to be driven are long and considerably different. For this reason, the driving conditions may change between the switching elements 3, resulting in a decrease in operation stability.

### SUMMARY OF THE INVENTION

The present invention provides a low-profile, compact, and narrow power conversion apparatus which uses solar cells as an input power supply and has a high power conversion efficiency. The present invention also provides a power conversion apparatus having a high operation stability. The present invention further provides a low-profile, compact, and narrow solar power generation system which has a high power conversion efficiency and high area power generation efficiency.

More specifically, according to the present invention, there is provided a power conversion apparatus having a plurality of transformers, each of the plurality of transformers comprises an input terminal having a first polarity, an input terminal having a second polarity, a wiring unit to connect one end of a primary winding of the transformer to the input terminal having the first polarity and the other end of the primary winding of the transformer to the input terminal having the second polarity, and a switching element which is arranged in series between the wiring unit and the other end to control voltage application to the primary winding of the transformer, wherein part of the wiring unit is connected to one end or the other end to surround the transformer connected to the wiring unit.

According to the present invention, there is also provided a solar power generation system comprising a solar cell and the power conversion apparatus.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view showing an example of the layout of components according to the first embodiment of the present invention;

FIG. 2 is a circuit diagram showing a circuit arrangement according to the first embodiment of the present invention;

FIG. 3 is a view showing another example of the layout according to the first embodiment of the present invention;

FIG. 4 is a view showing an example of the layout of components according to the third embodiment of the present invention;

FIG. 5 is a perspective view showing an example of the structure of a transformer according to the first embodiment of the present invention;

FIG. 6 is a plan view of the transformer according to the first embodiment of the present invention:

FIG. 7 is a view showing an example of the arrangement of a solar power generation system according to the second embodiment of the present invention;

FIG. 8 is a view showing an example of the structure of a solar cell according to the second embodiment of the present invention;

FIG. 9 is a circuit diagram showing an example of a conventional circuit arrangement;

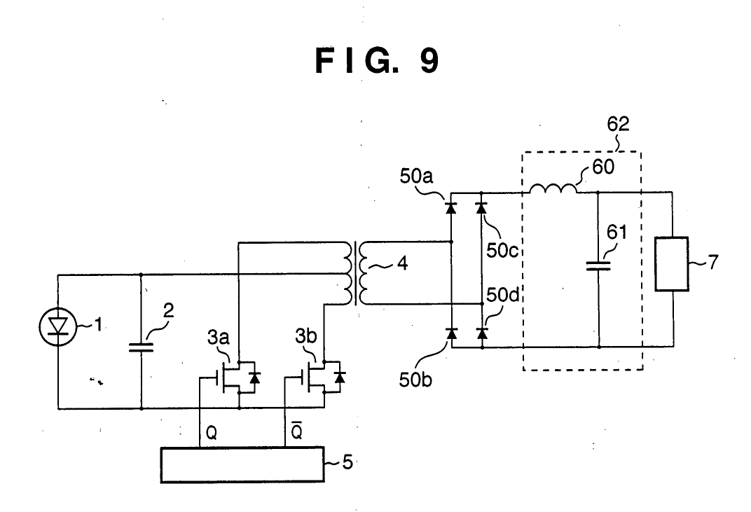

FIG. 10 is a circuit diagram showing another example of the conventional circuit arrangement;

FIG. 11 is a view showing an arrangement of a conventional DC/DC converter;

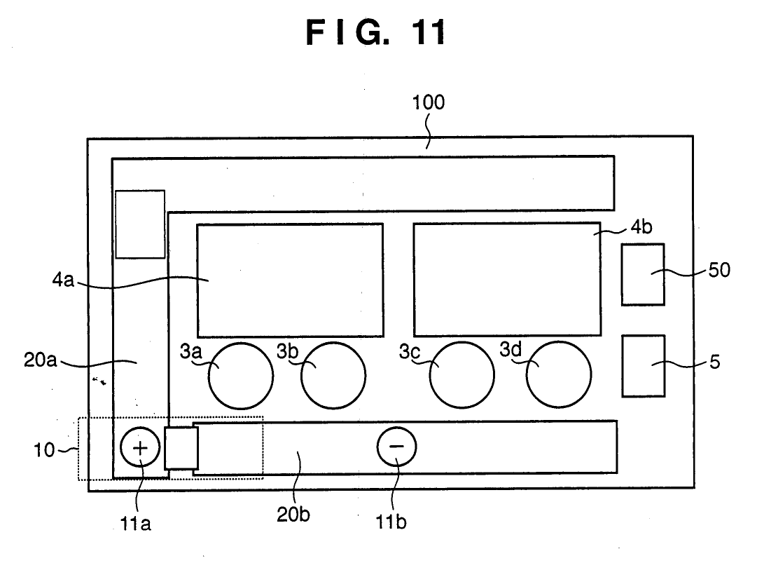

FIG. 12 is a view showing an example of a conventional solar power generation system; and

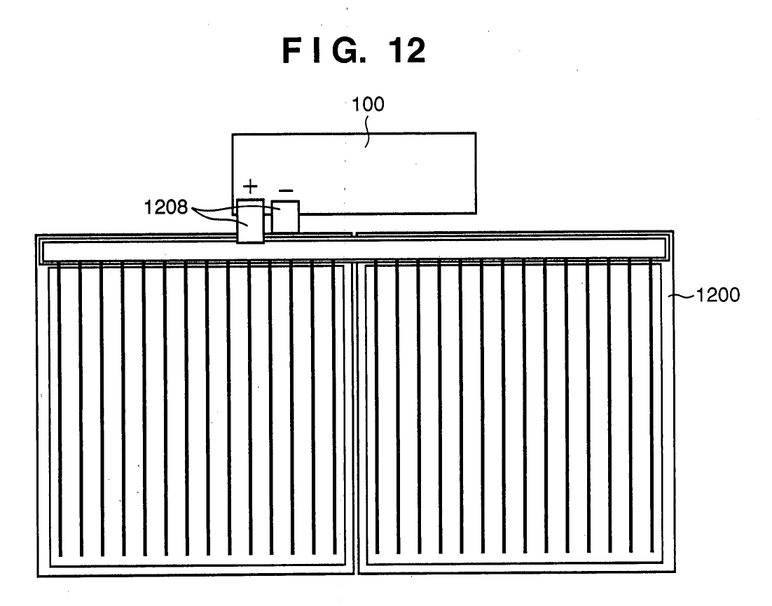

FIG. 13 is a circuit diagram showing a circuit arrangement according to the third embodiment of the present invention.

### DETAILED DESCRIPTION OF THE PREFERRED EMBODIMENTS

Preferred embodiments of the present invention will now be described in detail in accordance with the accompanying drawings.

A power conversion apparatus according to the present invention has an input terminal which receives an output from a solar cell, and at least two transformers. This power conversion apparatus has main circuit wiring units each having one input terminal connected to one end of a primary winding of each of the plurality of transformers and the other input terminal connected the other end of the primary winding of each of the plurality of transformers. The apparatus also comprises at least one switching element corresponding to each transformer, which is series-inserted between the main circuit wiring units to control voltage application to the primary winding of each transformer. At least some of the main circuit wiring units are individually wired to the input terminals of the respective transformer. In addition, these main circuit wiring units are laid out to surround the connected transformers.

Various kinds of circuit schemes can be applied to the power conversion apparatus, including a push-pull circuit, full-bridge circuit, half-bridge circuit, forward circuit, and flyback circuit. To obtain a high power conversion efficiency when, for example, a low-voltage large-current power from a solar cell is received, a push-pull circuit or full-bridge circuit is preferably used.

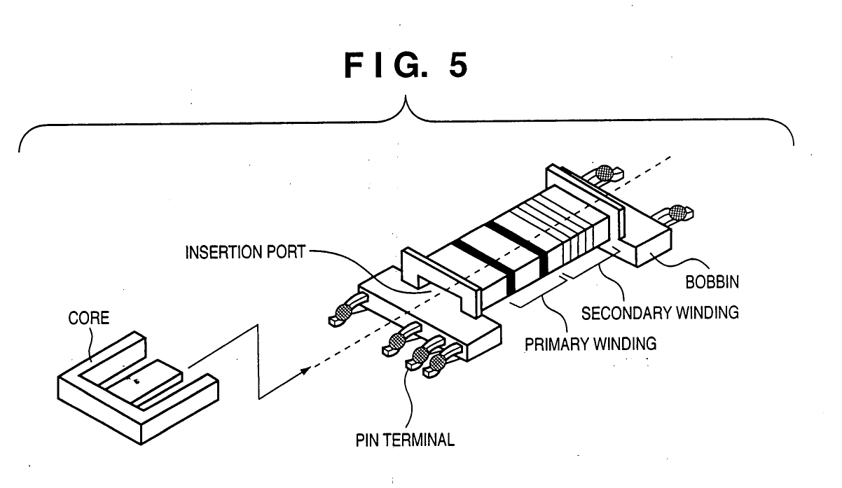

A transformer preferably has a low-profile shape, and its core material and shape and the manner of winding are not particularly limited. For example, a transformer shown in the perspective view of FIG. 5 can be used. This is an example of a low-profile EE transformer, which is formed by winding a primary winding and secondary winding around a bobbin and inserting the center legs of cores from both sides to the insertion hole of the bobbin. The primary and secondary windings are bound and fixed on the pin terminals of the bobbin, as needed. At least two transformers suffice. The number of transformers is not particularly limited and can be, for example, three or four. The two ends of the primary winding are preferably led out in reverse (or opposite) directions with respect to the transformer core. Especially in a push-pull circuit, when winding end portions which form the center taps of two primary windings are led out in the same direction with respect to the transformer core, the wiring length between the end portions of the primary windings, which form the center taps, can be shortened. Hence, the wiring resistance can be reduced.

The two transformers are preferably arranged parallel with respect to a side of a solar cell, where the power conversion apparatus and solar cell are connected. The windings of the transformers can be led out in any direction with respect to the side. For example, the lead-out direction may be either parallel or perpendicular to the side.

The switching element is not particularly limited. A MOSFET is preferably used from the viewpoint of the power conversion efficiency for a low-voltage large-current power from the solar cell.

The primary windings and secondary windings of the plurality of transformers are connected in parallel or series. The primary windings are preferably connected in parallel. The secondary windings can be connected either in parallel or in series. When the step-up ratio is high, the turn ratio of one transformer can be decreased by connecting the secondary windings in series. This is advantageous in increasing the power conversion efficiency and reducing the size of the transformer.

Any material that electrically has a low resistance can be used for the main circuit wiring unit. Copper, aluminum, silver, or an alloy based thereon can appropriately be used. Copper or a copper alloy is preferably used because of its low resistance and cost. The main circuit wiring unit may be formed from a conductor on a printed circuit board. Alternatively, a conductor on a metal base board or a plate or rod-shaped member may be used.

In a push-pull circuit, each of the plurality of transformers has two primary windings. One end of each primary winding in a single transformer is connected to one input terminal of the main circuit wiring unit. The other end of each primary winding in a single transformer is connected to the other input terminal of the main circuit wiring unit through a switching element.

The solar cell used in the solar power generation system according to the present invention only needs to have a positive pole and negative pole at least at one portion. The solar cell is not particularly limited, and a cell which outputs a low-voltage large-current power is preferably used. Various materials such as crystalline silicon, thin-film silicon, CIS, and color sensitizer can be used for the power generation layer of the solar cell. A stacked solar cell formed by stacking a plurality of power generation layers made of the same material or different materials can also be used.

The substrate of the solar cell is not particularly limited, and a glass substrate, metal substrate, film substrate, or the like can be used. The number of solar cells connected in series is preferably small and, for example, 1 to 10 such that the voltage becomes low, although it is not particularly limited. More preferably, the number of solar cells connected in series is 1 to 4.

Most preferably, the number of solar cells connected in series is 1 because no mismatch loss due to the difference in voltage versus current characteristic curve between a plurality of solar cells connected in series is generated even when partial shade occurs, that is, when the solar cell is partially shaded.

The control circuit which ON/OFF-controls the switching element is not particularly limited. Any known public circuit such as an analog circuit, digital circuit, or a combination thereof can appropriately be used. In addition, various pulse control methods can be used, including variable duty methods such as PWM, PFM, PNM or fixed duty methods, or a combination thereof.

The power supply to the power conversion apparatus of the present invention is not limited to the solar cell. Any other power supply such as a fuel battery, primary battery, or secondary battery can be used.

[First Embodiment]

An embodiment of the present invention will be described below with reference to the accompanying drawings.

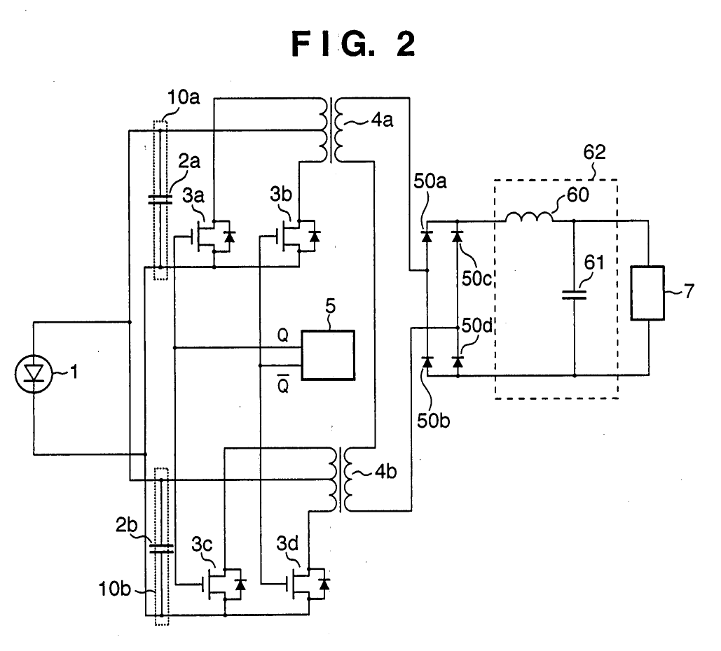

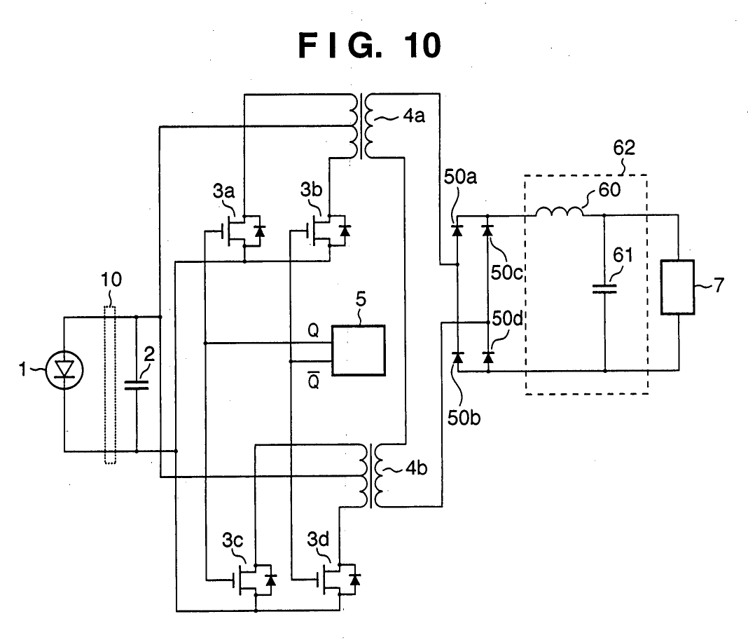

FIG. 2 shows a circuit arrangement of a DC/DC converter serving as a power conversion apparatus according to the present invention. This embodiment has almost the same arrangement as in FIG. 10 except that a smoothing capacitor 2 is separated to smoothing capacitors 2a and 2b, which are arranged respectively for the input units of two push-pull units. An output filter 62 formed from an output smoothing choke 60 and output smoothing capacitor 61 is arranged outside the DC/DC converter main body on the load side.

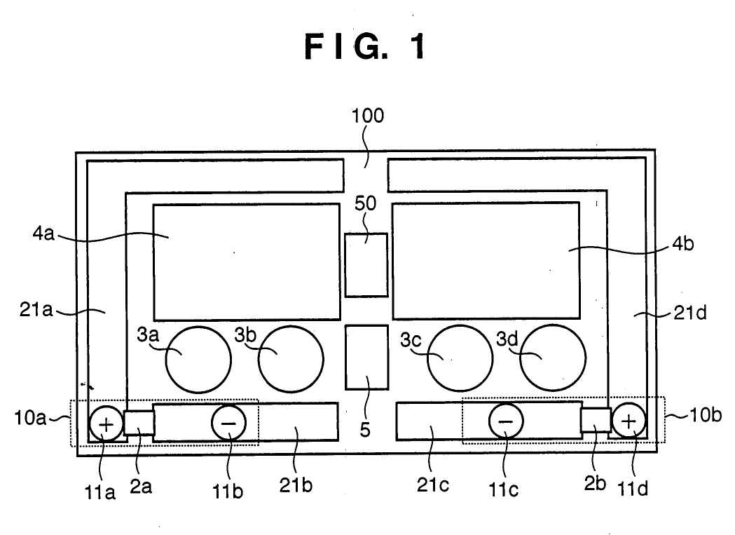

FIG. 1 shows an example of the layout of components according to the first embodiment of the present invention. The same reference numerals with different suffixes for identification indicate identical constituent elements (this also applies to the remaining drawings). A control circuit 5 and rectifying circuit 50 are arranged at the center of a DC/DC converter 100. The remaining members are arranged symmetrically on the left and right sides. Two transformers 4a and 4b are arranged symmetrically on the left and right sides.

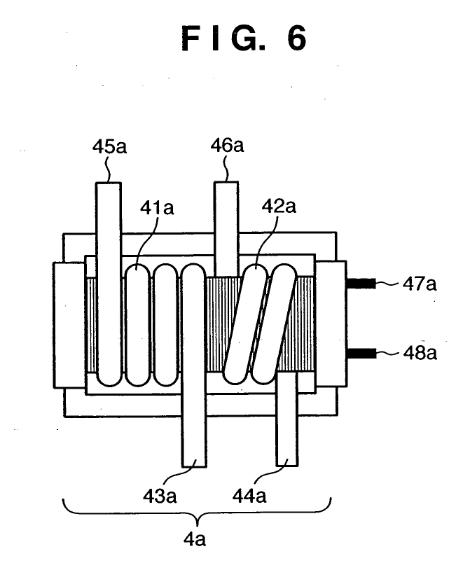

FIG. 6 is a plan view of the transformer 4a. The transformer 4a has two primary windings 41a and 42a outside a secondary winding (not shown). End portions 45a and 46a of the primary windings, which serve as the center taps of the primary windings, are led out and connected to positive-side main circuit wiring units 21a and 21d. The other end portions 43a and 44a as the other ends of the primary windings are led out in a direction reverse to the center-tap-side end portions 45a and 46a with respect to the core and connected to switching elements 3a and 3b.

An end 47a of the lead-out portion of the secondary winding is connected to the intermediate portion between diodes 50a and 50b. The other end 48a is connected in series with one end of the secondary winding of the other transformer 4b. The other end of the secondary winding of the transformer 4b is also connected to the intermediate portion between diodes 50c and 50d.

The switching elements are connected to negative-side main circuit wiring units 21b and 21c. In accordance with driving signals from the control circuit 5, the two terminals, on both sides of the center taps of the primary windings, of each of the transformers 4a and 4b, are alternately turned on/off with respect to the negative-side main circuit wiring units 21b and 21c. When switching elements 3 are inserted between the negative-side main circuit wiring units and the two terminals, on both sides of the center taps of the primary windings, of each transformer 4, low-loss NMOSFETs can be used.

The negative-side main circuit wiring units 21b and 21c are arranged on the lower side of FIG. 1. The positive-side main circuit wiring units 21a and 21d are arranged in a predetermined width along the upper side and left and right sides of FIG. 1. The smoothing capacitors 2a and 2b are connected between the negative and positive-side main circuit wiring units to the respective push-pull units. Portions indicated by dotted lines are connection units 10a and 10b serving as input terminals which input the output from the solar cell to the respective push-pull units. The connection units 10a and 10b have positive input terminals 11a and lid and negative input terminals 11b and 11c, respectively.

In the present invention, the main circuit wiring units include the main circuit wiring units 21a and 21b (21d and 21c) shown in FIG. 1, a wire (not illustrated in FIG. 1) which connects the switching element 3a (3c) to one end of one primary winding of the transformer 4a (4b) in FIG. 2, and a wire (not illustrated in FIG. 1) which connects the switching element 3b (3d) to one end of the other primary winding of the transformer 4a (4b) in FIG. 2. In this embodiment, the wires that are not illustrated in FIG. 1 are very short, and a description thereof will be omitted.

The width of each of the positive and negative-side main circuit wiring units is set to, for example, about 0.6 times (6 mm if the conventional width is 10 mm) of the conventional width such that the wiring loss becomes equal to or less than before. Accordingly, the width of the DC/DC converter in the vertical direction in FIG. 2 can be decreased while suppressing the decrease in its power conversion efficiency.

In this arrangement, since the wiring resistances from the solar cell to the primary windings in the two transformers equal to each other, and powers supplied to the two transformers balance, the power conversion efficiency increases, and a stable operation can be performed. In addition, since the common wiring path of the two transformers is omitted as much as possible, and separate wiring paths are formed, the operation of one conversion unit less affects the other, and the operation can be stabilized.

Furthermore, the wiring lengths between the two terminals of the two smoothing capacitors 2a and 2b and the positive and negative poles of the solar cell are shortened. Since the total wiring length of the primary-side power conversion circuit is shortened, the parasitic inductance can be reduced, and a noise-free stable operation can be ensured.

One end and the other end of each primary winding of the transformer are led out in reverse directions with respect other core. In addition, the ends of the primary windings, which constitute the center taps of the set of primary windings, are led out in the same direction with respect to the core. With this structure, the connection wiring length between the center taps is shortened. Since the resistance becomes low, the power conversion efficiency can be increased.

The control circuit 5 is arranged almost at the intermediate portion between the two transformers. Since the distances from the control circuit 5 to the switching elements 3 are almost equal, the driving conditions are uniformed, and the operation stabilizes. In addition, since the maximum distance from the control circuit 5 to the switching element 3 can be shortened, the influence of the parasitic inductance decreases, and the influence of noise can be suppressed.

In this embodiment, the main circuit wiring unit is short in the horizontal direction in FIG. 1 and is separated into a plurality of units, as compared to the prior art. For these reasons, thermal stress generated by the difference in expansion coefficient can easily be relaxed. Hence, warping of the printed circuit board can be suppressed, and the reliability can be increased. This structure is particularly effective when the DC/DC converter is used outdoors where the temperature changes largely.

The width of each main circuit wiring unit is set to about 0.6 times of the prior art. However, the present invention is not limited to this, and the design can appropriately be changed by placing the importance on the efficiency, width, or the like. In addition, the width of each portion can be changed in accordance with the amount of the current flowing to the main circuit wiring unit.

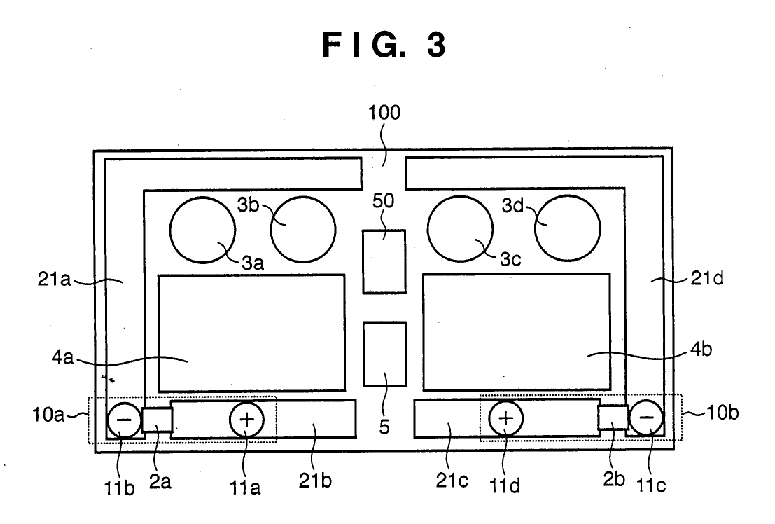

In this embodiment, the components are laid out as shown in FIG. 1. One end of each primary winding, which constitutes its center tap, is led out to the upper side of FIG. 1 and connected to the main circuit wiring unit 21a so that this end is connected to the positive input terminal 11a of the connection unit 10a to which the output from the solar cell is input. The other end of each primary winding is led out to the lower side of FIG. 1 and connected to the main circuit wiring unit 21b through the switching elements 3a and 3b so that the other end is connected to the negative input terminal 11b of the connection unit 10a to which the output from the solar cell is input. However, the present invention is not limited to this, and various changes and modifications can be made. For example, as shown in FIG. 3, one end of each primary winding, which constitutes its center tap, may be led out to the lower side of FIG. 3 and connected to the main circuit wiring unit 21b through the switching elements 3a and 3b so that this end is connected to the positive input terminal 11a of the connection unit 10a to which the output from the solar cell is input. The other end of each primary winding may be led out to the upper side of FIG. 3 and connected to the main circuit wiring unit 21a so that the other end is connected to the negative input terminal 11b of the connection unit 10a to which the output from the solar cell is input.

As described above, in this embodiment, main circuit wiring units are arranged separately for the transformers. In addition, the main circuit wiring units for each transformer are laid out to surround the transformer. With this arrangement, the current density of the main circuit wiring unit can be reduced, and the wiring resistance loss in the main circuit wiring unit can be reduced. Furthermore, since the wiring width of the main circuit wiring unit can be decreased in accordance with the decrease in loss, the power conversion apparatus can be made narrow. Accordingly, a low-profile, compact, and narrow power conversion apparatus having a high power conversion efficiency can be obtained.

When the ends of the primary windings, which constitute the center taps of the set of primary windings in the transformer, are led out in the same direction with respect to the transformer core, the wiring length necessary for connecting the center taps can be shortened. For this reason, the wiring resistance becomes low.

The control circuit which ON/OFF-controls the switching elements is arranged almost at the intermediate portion between the plurality of transformers. Since the distances from the control circuit to the switching elements are almost equal, the driving conditions are uniformed, and the operation stabilizes.

[Second Embodiment]

Another embodiment of the present invention will be described next.

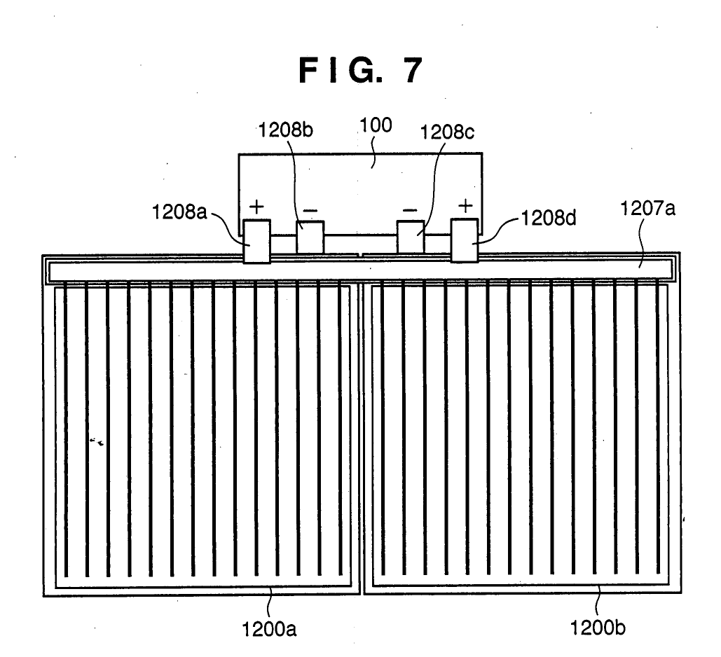

FIG. 7 shows the arrangement of a solar power generation system according to the present invention. This solar power generation system includes a DC/DC converter 100 described in the first embodiment and two solar cells 1200 (1200a and 1200b).

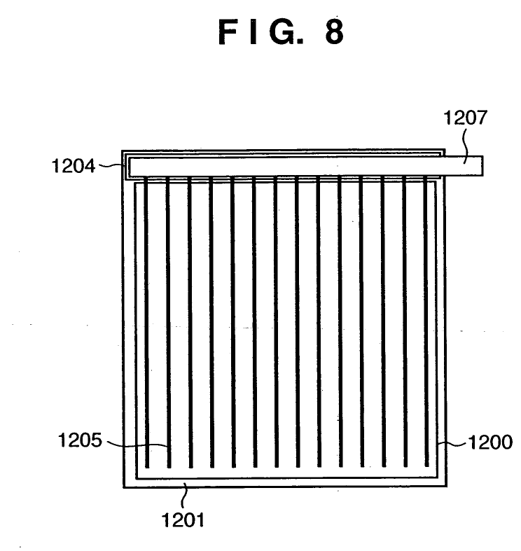

The solar cell 1200 will be described with reference to FIG. 8. FIG. 8 shows an example of the upper surface (light-receiving surface) of the solar cell. The solar cell 1200 is formed on a conductive substrate 1201. A plurality of first electrodes 1205 having a high conductivity are arrayed on the light-receiving surface to collect the current from the power generation layer of the solar cell at low loss. The first electrodes 1205 are electrically connected, on the upper side of FIG. 8, to a second electrode 1207 on the light-receiving surface side. The second electrode 1207 having a higher conductivity collects the current from each first electrode 1205 at low loss. An insulating film 1204 is inserted between the second electrode 1207 and the substrate 1201 to prevent short-circuit between solar cells. The substrate 1201 is used as another electrode of the solar cell by using its conductivity.

Although not illustrated, a back electrode having a conductivity higher than that of the substrate 1201 is formed at part of the substrate to collect at lower loss. The solar cell 1200 has a positive pole on the light-receiving surface side and a negative pole on the lower surface side.

The two solar cells 1200 each having the above-described basic structure are laid out as shown in FIG. 7. Instead of forming the second electrode 1207 on the light-receiving surface side for each solar cell 1200, a second electrode 1207a as a common member for the two solar cells 1200 is formed.

The two solar cells 1200 are electrically connected to connection units 10 of the DC/DC converter 100 by using four conductive connection members 1208. One terminal of a connection member 1208a is electrically connected to the second electrode 1207a of the solar cells 1200. The other terminal of the connection member 1208a is electrically connected to a connection unit 10a of a main circuit wiring unit 21a of the DC/DC converter 100 shown in FIG. 1. One terminal of a connection member 1208b is electrically connected to the back electrode of the solar cell 1200. The other terminal of the connection member 1208b is electrically connected to the connection unit 10a of a main circuit wiring unit 21b of the DC/DC converter 100 shown in FIG. 1. One terminal of a connection member 1208c is electrically connected to the back electrode of the solar cell 1200. The other terminal of the connection member 1208c is electrically connected to a connection unit 10b of a main circuit wiring unit 21c of the DC/DC converter 100 shown in FIG. 1. One terminal of a connection member 1208d is electrically connected to the second electrode 1207a of the solar cells 1200. The other terminal of the connection member 1208d is electrically connected to the connection unit 10b of a main circuit wiring unit 21d of the DC/DC converter 100 shown in FIG. 1.

This solar power generation system is thin. The projecting width of the DC/DC converter 100 from the solar cells 1200 can be decreased while keeping its power conversion efficiency high. Since the dead space in the installation area become small, the area power generation efficiency increases.

The solar power generation system is thin, and the DC/DC converter 100 has a small projecting width from the solar cells 1200. These can minimize the risk that something hits or scratches the DC/DC converter 100 to break or damage it. In addition, the workability in installation and transportation increases.

Since the solar power generation system is thin and narrow in the vertical direction, packing members and the space for transportation can be saved. Hence, the packing and transportation cost can be reduced.

[Third Embodiment]

Still another embodiment of the present invention will be described.

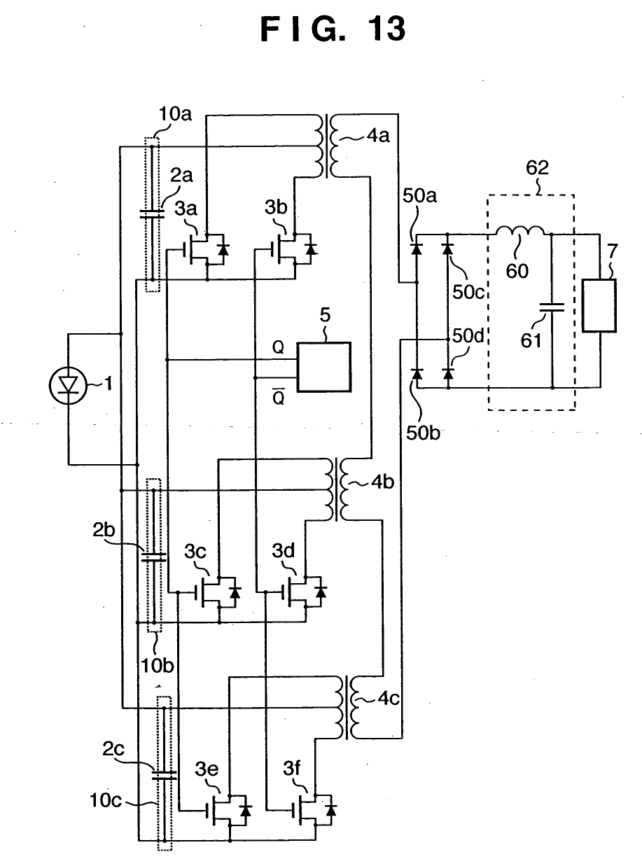

A DC/DC converter 100 according to this embodiment has three push-pull units, unlike the first embodiment. The primary winding sides of transformers 4a to 4c are connected in parallel, and the secondary winding sides of the transformers 4a to 4c are connected in series, as in the first embodiment. FIG. 13 is a circuit diagram showing a circuit arrangement according to this embodiment.

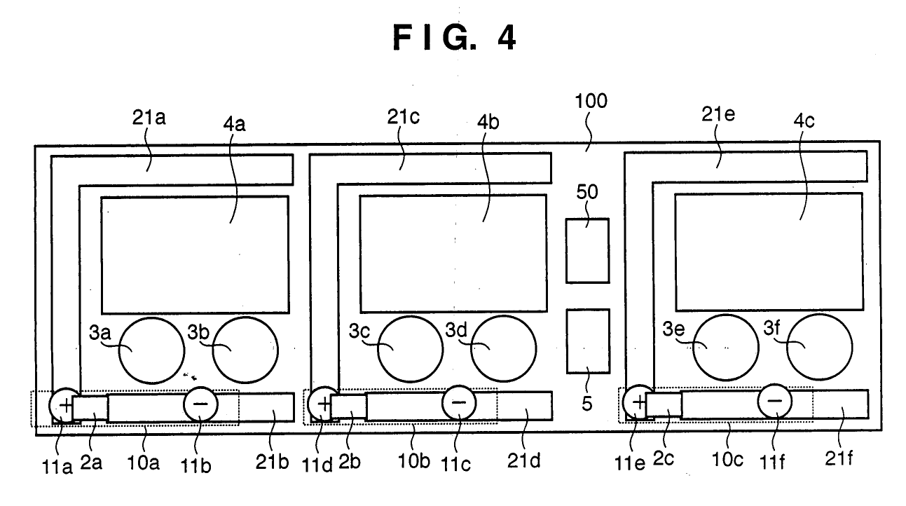

FIG. 4 shows the component layout of the DC/DC converter according to this embodiment. Positive-side main circuit wiring units 21a, 21c, and 21e are laid out in an L shape and connected to the center tap sides of the primary windings of the transformers 4a to 4c, respectively. Negative-side main circuit wiring units 21b, 21d, and 21f are arranged on the lower side of FIG. 4 and connected to switching elements 3a and 3b, 3c and 3d, and 3e and 3f, respectively.

The switching element 3a is connected to one of the two terminals of the transformer 4a on both sides of the center taps of the primary windings. The switching element 3b is connected to the other of the two terminals of the transformer on both sides of the center taps of the primary windings. The switching elements 3c and 3d, and 3e and 3f are also connected to the transformers 4b and 4c, respectively, in a similar manner. A control circuit 5 and rectifying circuit 50 can be arranged at, for example, positions shown in FIG. 4 between the push-pull units.

As described above, the main circuit wiring units 21a to 21f are laid out separately for the push-pull units to surround the transformers 4a to 4c of the push-pull units. In this arrangement, the current from the solar cell is divided into three components and distributed to the push-pull units. For this reason, when the width of the main circuit wiring unit is the same as in the prior art, the current density can be reduced to ⅓. If the loss should be equal to or less than before, the width of the main circuit wiring unit 21 can be reduced.

For example, the width may be about 0.5 times of the prior art. Accordingly, the width in the vertical direction in FIG. 4 can be reduced while maintaining (or increasing) the power conversion efficiency of the low-profile DC/DC converter 100.

As described above, even the low-profile DC/DC converter having three transformers can reduce its width, like or more efficiently than a DC/DC converter having two transformers. A DC/DC converter having four or more transformers can also be formed.

As described above, according to the present invention, a low-profile, compact, and narrow power conversion apparatus having a high power conversion efficiency can be obtained.

In addition, a solar power generation system having solar cells and the above-described power conversion apparatus can be made thin, and the projecting width of the power conversion apparatus from the solar cells can be decreased while keeping its power conversion efficiency high. For this reason, the area power generation efficiency of the solar power generation system increases.

As many apparently widely different embodiments of the present invention can be made without departing from the spirit and scope thereof, it is to be understood that the invention is not limited to the specific embodiments thereof except as defined in the appended claims.

What is claimed is:

1. A power conversion apparatus having a plurality of transformers, each of said plurality of transformers comprising:
an input terminal having a first polarity;
an input terminal having a second polarity;
a wiring unit to connect one end of a primary winding of said transformer to said input terminal having the first polarity and the other end of the primary winding of said transformer to said input terminal having the second polarity; and
a switching element which is arranged in series between said wiring unit and said other end to control voltage application to the primary winding of said transformer,
wherein part of said wiring unit is connected to one of said one end and said other end to surround said transformer connected to said wiring unit.

2. The apparatus according to claim 1, wherein said one end and said other end of the primary winding of said transformer are arranged to oppose with respect to a core of said transformer, and
said one end of said transformer is more separated from said input terminal than said other end.

3. The apparatus according to claim 1, wherein said one end and said other end of the primary winding of said transformer are arranged to oppose with respect to a core of said transformer, and
said other end of said transformer is more separated from said input terminal than said one end.

4. The apparatus according to claim 1, further comprising a control circuit which is arranged between two of said plurality of transformers to control an operation of said switching element.

5. The apparatus according to claim 1, wherein said transformer is a push-pull transformer, and
a first end which is one end of a first primary winding of the primary windings and is connected to said input terminal having the first polarity and a second end which is one end of a second primary winding and is connected to said input terminal having the first polarity are connected to said input terminal having the first polarity by part of said wiring unit.

6. The apparatus according to claim 1, wherein said transformer is a push-pull transformer, and the first other end which is other end of a first primary winding of the primary windings and is connected to said input terminal having the second polarity and the second other end which is other end of a second primary winding and is connected to said input terminal having the second polarity are connected to said input terminal having the second polarity by part of said wiring unit.

7. The apparatus according to claim 1, wherein a power from a solar cell is input to said input terminals.

8. A solar power generation system comprising a solar cell and a power conversion apparatus of claim 1.
